(19) United States
(12) Patent Application Publication
(10) Pub. No.: US 2026/0342726 A1
(43) Pub. Date: Oct. 29, 2026

(54) METHOD AND NETWORK DEVICE FOR TRANSMITTING DATA USING NETWORK FILE SYSTEM

(71) Applicant: National Yang Ming Chiao Tung University, Hsinchu City (TW)

(72) Inventors: Shie-Yuan WANG, Hsinchu City (TW); Ting-Wei YU, Zhudong Township (TW)

(21) Appl. No.: 19/299,439

(22) Filed: Aug. 14, 2025

(30) Foreign Application Priority Data
Apr. 23, 2025 (TW) 114115362

(51) Int. Cl. H04L 45/74

(52) U.S. Cl. CPC H04L 45/74

(57) ABSTRACT

A method includes: when receiving a request packet, recording an XID of the request packet, setting a state of the XID as a “REQUESTED” state, obtaining a remainder, dropping the request packet when the remainder is not equal to zero, when the remainder is equal to zero, setting a counter value to zero, obtaining a mirrored request packet, forwarding the mirrored request packet to a server, modifying the request packet into a worker packet, modifying the XID and the offset of the worker packet, obtaining a mirrored worker packet, modifying the mirrored worker packet into a prefetched packet, forwarding the prefetched packet to the server, and recirculating the worker packet; when receiving a reply packet, determining whether the state of the XID of the reply packet is a “PRE-FETCH” state, and forwarding the reply packet to a client when a result of the determination is negative.

### CROSS-REFERENCE TO RELATED APPLICATION

This application claims priority to Taiwanese Invention Patent Application No. 114115362, filed on Apr. 23, 2025, the entire disclosure of which is incorporated by reference herein.

### FIELD

The disclosure relates to a method and a network device for transmitting data using Network File System (NFS).

### BACKGROUND

Network File System (NFS) is a distributed file system protocol, and allows clients at different locations to access files stored on a remote server as if the files were locally stored. Remote Procedure Call (RPC) protocol is used in transmission of requests and replies between a client and a server for accessing a file under NFS. However, like the Stop-and-Wait ARQ protocol, using RPC protocol would cause throughput to inversely decrease when a round-trip time (RTT) between the client and the server increases.

### SUMMARY

Therefore, an object of the disclosure is to provide a method and a network device for transmitting data using Network File System (NFS) that can alleviate at least one of the drawbacks of the prior art.

According to one aspect of the disclosure, the network device is adapted to communicate with at least one client device and an NFS server. The at least one client device sequentially sends multiple NFS request packets via the network device to the NFS server for accessing a specific file stored in the NFS server. The NFS server sequentially sends multiple NFS reply packets that respectively correspond to the NFS request packets via the network device to the at least one client device for providing the specific file to the at least one client device. Each of the NFS request packets and the NFS reply packets includes a header that contains a transaction identifier (XID). The XID of one of the NFS request packets and the XID of a corresponding one of the NFS reply packets are identical. The XIDs respectively of the NFS request packets sequentially sent to the NFS server are sequential. Each of the NFS request packets at least contains an offset that is defined by NFS and that is an integer. Each of the headers of the NFS request packets and the NFS reply packets indicates a packet type. The network device includes an ingress match-action pipeline (IMAP) module, a traffic manager and packet buffer (TMPB) module, an egress match-action pipeline (EMAP) module, a mirror buffer, a recirculation port, a pre-fetch counter and a storage-manager register. The TMPB module is electrically connected to the IMAP module. The EMAP module is electrically connected to the TMPB module. The mirror buffer is electrically connected to the IMAP module, the TMPB module and the EMAP module. The recirculation port is electrically connected to the IMAP module and the EMAP module.

The IMAP module is configured to receive the NFS request packets from the at least one client device, to send the NFS request packets thus received to the TMPB module, to receive the NFS reply packets from the NFS server, and to send the NFS reply packets thus received to the TMPB module.

In response to receiving one request packet among the NFS request packets from the IMAP module, the TMPB module is configured to record the XID contained in the request packet in the storage-manager register, set, in the storage-manager register, a state of the XID thus recorded as a “REQUESTED” state, and perform a modulo operation to obtain a remainder of a division of the offset contained in the request packet by a product of a preset block size and a preset pre-fetch number, where the preset block size is defined by NFS and each of the preset block size and the preset pre-fetch number is a positive integer. The “REQUESTED” state indicates that the network device has received one of the NFS request packets that corresponds to the XID thus recorded from the at least one client device but has not yet received a corresponding one of the NFS reply packets from the NFS server. In the case that the remainder is not equal to zero, the TMPB module is configured to drop the request packet. In the case that the remainder is equal to zero, the TMPB module is configured to set a counter value recorded in the pre-fetch counter to zero, mirror the request packet to obtain, in the mirror buffer, a mirrored copy of the request packet, forward the mirrored copy of the request packet to the NFS server through the EMAP module, modify the packet type indicated by the header of the request packet to obtain a worker packet, modify the XID contained in the worker packet into one of the XIDs that is immediately subsequent to the XID of the worker packet, and modify the offset contained in the worker packet by incrementing the offset by the preset block size. In the case that the remainder is equal to zero, the TMPB module is further configured to, after modifying the XID and the offset contained in the worker packet, mirror the worker packet to obtain, in the mirror buffer, a mirrored copy of the worker packet, modify the packet type of the mirrored copy of the worker packet to obtain a prefetched packet identical to a next one of the NFS request packets that is immediately subsequent to the request packet from which the worker packet is derived and that is to be sent to the NFS server, forward the prefetched packet to the NFS server through the EMAP module, and after modifying the XID and the offset contained in the worker packet, recirculate the worker packet from the EMAP module to the IMAP module via the recirculation port.

In response to receiving one reply packet among the NFS reply packets from the IMAP module, the TMPB module is further configured to determine whether the state of the XID contained in the reply packet and that has been recorded in said storage-manager register is a “PRE-FETCH” state, which indicates that one of the NFS request packets that corresponds to the XID contained in the reply packet was generated by the network device and sent to the NFS server before receiving said one of the NFS request packets from the at least one client device. In response to determining that the state of the XID is not the “PRE-FETCH” state, the TMPB module is further configured to forward the reply packet to the at least one client device through said EMAP module.

According to another aspect of the disclosure, the method is adapted to be implemented by the network device that was previously described. The method includes steps of:
in response to receiving one request packet among the NFS request packets,
   recording the XID contained in the request packet in the storage-manager register,
   setting, in the storage-manager register, a state of the XID thus recorded as a “REQUESTED” state, which indicates that the network device has received one of the NFS request packets that corresponds to the XID thus recorded from the at least one client device but has not yet received a corresponding one of the NFS reply packets from the NFS server,
   performing a modulo operation to obtain a remainder of a division of the offset contained in the request packet by a product of a preset block size and a preset pre-fetch number, where the preset block size is defined by NFS and each of the preset block size and the preset pre-fetch number is a positive integer,
   in the case that the remainder is not equal to zero, dropping the request packet,
   in the case that the remainder is equal to zero,
      setting a counter value recorded in the pre-fetch counter to zero,
      mirroring the request packet to obtain a mirrored copy of the request packet,
      forwarding the mirrored copy of the request packet to the NFS server,
      modifying the packet type indicated by the header of the request packet to obtain a worker packet,
      modifying the XID contained in the worker packet into one of the XIDs that is immediately subsequent to the XID of the worker packet,
      modifying the offset contained in the worker packet by incrementing the offset by the preset block size,
      after modifying the XID and the offset contained in the worker packet, mirroring the worker packet to obtain a mirrored copy of the worker packet,
      modifying the packet type of the mirrored copy of the worker packet to obtain a prefetched packet identical to a next one of the NFS request packets that is immediately subsequent to the request packet from which the worker packet is derived and that is to be sent to the NFS server,
      forwarding the prefetched packet to the NFS server, and
      after modifying the XID and the offset contained in the worker packet, recirculating the worker packet; and
in response to receiving one reply packet among the NFS reply packets,
   determining whether the state of the XID contained in the reply packet and that has been recorded in the storage-manager register is a “PRE-FETCH” state, which indicates that one of the NFS request packets that corresponds to the XID contained in the reply packet was generated by the network device and sent to the NFS server before receiving said one of the NFS request packets from the at least one client device, and
   in response to determining that the state of the XID is not the “PRE-FETCH” state, forwarding the reply packet to the at least one client device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating a network device for transmitting data using Network File System (NFS) according to an embodiment of the disclosure.

FIG. 2 is a flow chart illustrating a method for transmitting data using NFS according to a first embodiment of the disclosure.

FIG. 3 is a flow chart illustrating a method for transmitting data using NFS according to a second embodiment of the disclosure.

FIG. 4 is a block diagram illustrating the network device according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

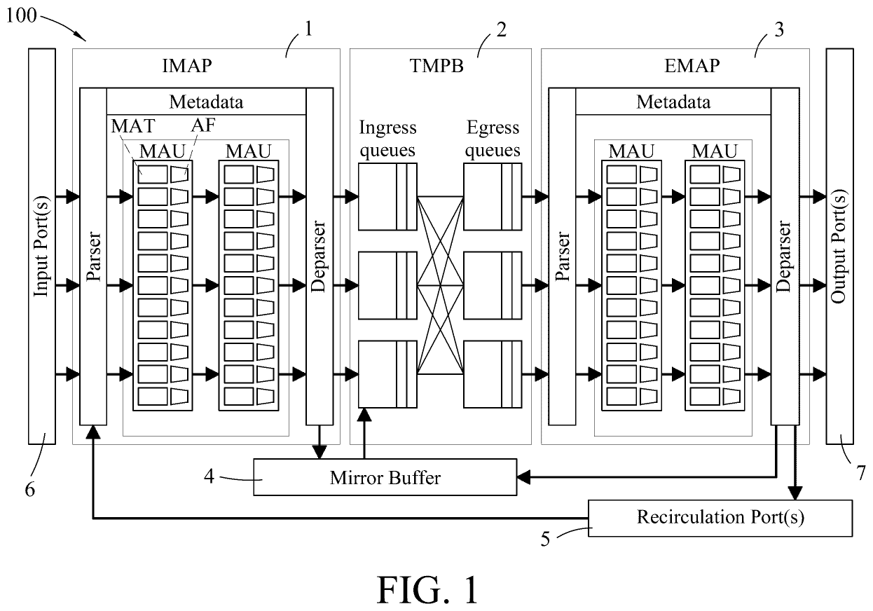

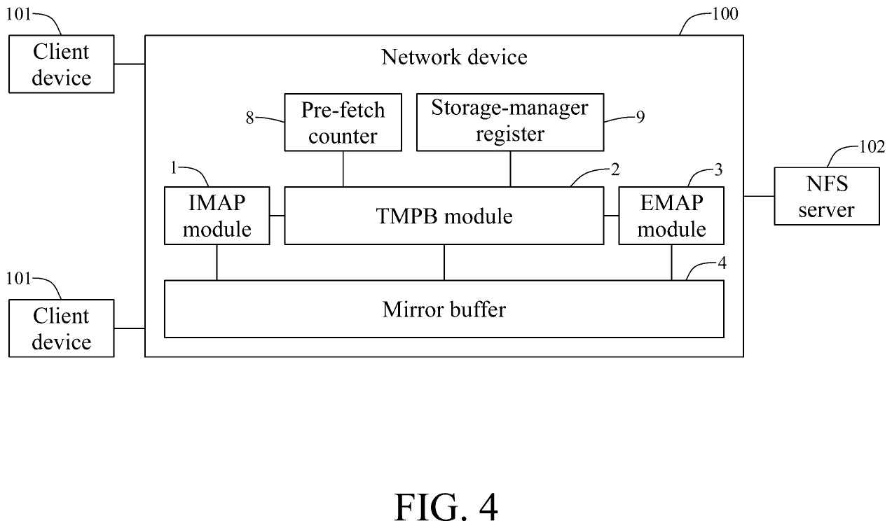

Referring to FIGS. 1 and 4, an embodiment of a network device 100 for transmitting data using Network File System (NFS) according to the disclosure is illustrated. In particular, NFS version 3 (NFVv3) is followed in this embodiment, but is not limited thereto. The network device 100 is adapted to communicate with at least one client device 101 and an NFS server 102. In this embodiment, the network device 100 is implemented by a Programming Protocol-independent Packet Processors (P4) hardware switch (more specifically the Intel Tofino ASIC), but is not limited thereto. For example, in some embodiments, the network device 100 may be implemented to be a network switch, a network interface card, a router, and so on. It is worthy of note that P4 is a domain-specific language, and is a programmable data plane technology allowing developers to design and realize packet processing logics in a data plane of a computer network. Each of the at least one client device 101 and the NFS server 102 may be implemented by a desktop computer, a laptop computer, a notebook computer, a tablet computer, a computing server or a data server, but implementation thereof is not limited to what are disclosed herein and may vary in other embodiments.

In the case that NFS is used, an accessed file is divided into multiple data blocks for data transmission, where each of the data blocks has a preset block size that is defined by NFS and that is a positive integer. The at least one client device 101 sequentially sends multiple NFS request packets via the network device 100 to the NFS server 102 for accessing a specific file stored in the NFS server 102, e.g., for reading the specific file. In response, the NFS server 102 sequentially sends multiple NFS reply packets that respectively correspond to the NFS request packets via the network device 100 to the at least one client device 101 for providing the specific file to the at least one client device 101. Each of the NFS request packets and the NFS reply packets includes a header that contains a transaction identifier (XID). The XID of one of the NFS request packets and the XID of a corresponding one of the NFS reply packets are identical. The XIDs respectively of the NFS request packets sequentially sent to the NFS server 102 are sequential. Specifically, the XIDs contained in the NFS request packets sequentially sent to the NFS server (102) are consecutive positive integers. For example, the XIDs are exemplarily 300, 301, 302 and so on. Each of the NFS request packets at least contains an offset that is defined by NFS and that is an integer. In a scenario where the preset block size is 8 k (i.e., 8192) bytes, the offsets contained in the NFS request packets are sequentially 0, 8192, 16384 and so on. Each of the headers of the NFS request packets and the NFS reply packets indicates a packet type.

The network device 100 includes an ingress match-action pipeline (IMAP) module 1, a traffic manager and packet buffer (TMPB) module 2, an egress match-action pipeline (EMAP) module 3, a mirror buffer 4, a recirculation port 5, at least one input port 6, at least one output port 7, a pre-fetch counter 8 and a storage-manager register 9. The IMAP module 1 is electrically connected to the at least one input port 6. The TMPB module 2 is electrically connected to the IMAP module 1, the pre-fetch counter 8 and the storage-manager register 9. The EMAP module 3 is electrically connected to the TMPB module 2 and the at least one output port 7. The mirror buffer 4 is electrically connected to the IMAP module 1, the TMPB module 2 and the EMAP module 3. The recirculation port 5 is electrically connected to the IMAP module 1 and the EMAP module 3.

The IMAP module 1 is configured to receive the NFS request packets from the at least one client device 101, to send the NFS request packets thus received to the TMPB module 2, to receive the NFS reply packets from the NFS server 102, and to send the NFS reply packets thus received to the TMPB module 2. In addition, the IMAP module 1 is further configured to receive a recirculated packet from the EMAP module 3 via the recirculation port 5.

In brief, after a to-be-forwarded packet is received via the at least one input port 6, the to-be-forwarded packet will be sequentially processed by the IMAP module 1, the TMPB module 2 and the EMAP module 3, and then outputted via the at least one output port 7. After a to-be-recirculated packet is generated, the to-be-recirculated packet will be recirculated via the recirculation port 5 from the EMAP module 3 to the IMAP module 1, and then be sequentially processed by the IMAP module 1 and the TMPB module 2.

Each of the IMAP module 1 and the EMAP module 3 includes a parser, a plurality of match-action units (MAUs) and a deparser. The parser is configured to divide each incoming packet to obtain a header of the incoming packet, to extract information contained in the header of the incoming packet, and to pass the incoming packet to the MAUs. Each of the MAUs is realized by a set of match-action tables (MATs) and action functions (AFs). The MATs are defined by a set of match keys (e.g., information contained in a header of a packet, or an instance of intrinsic metadata that is used for matching and that is assigned by the network device 100 to a packet), and the AFs are operations to be applied to a packet. Each of the MAUs is configured to process the incoming packet based on the MATs. The deparser is configured to reassemble the incoming packet processed by the MAU, and to output the incoming packet.

The TMPB module 2 includes multiple ingress queues related to the at least one input port 6, multiple egress queues related to the at least one output port 7, and multiple scheduling functions for carrying out specific functionalities of this disclosure.

It is worth to note that intrinsic metadata is a data structure that is used to describe a current state of a packet or to specify an operation to be applied to a packet. For example, for each incoming packet, the IMAP module 1 is configured to generate an instance of intrinsic metadata so as to assign to the incoming packet an output port ID of one of the at least one output port 7, and an egress queue ID of one of the egress queues. The incoming packet will be enqueued onto one of egress queues for being outputted via said one of the at least one output port 7 based on the output port ID and the egress queue ID.

It should be noted that each of the IMAP module 1, the TMPB module 2 and the EMAP module 3 may be implemented by one of hardware, firmware, software, and any combination thereof. In particular, the above-mentioned modules may be embodied in: executable software as a set of logic instructions stored in a machine-readable or computer-readable storage medium of a memory such as random access memory (RAM), read only memory (ROM), programmable ROM (PROM), firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application specific integrated circuit (ASIC), complementary metal oxide semiconductor (CMOS), transistor-transistor logic (TTL) technology, etc.; or any combination thereof. For example, the IMAP module 1, the TMPB module 2 and the EMAP module 3 may be implemented to be software modules in a program, where the software modules contain codes and instructions to carry out specific functionalities, and can be called individually or together to fulfill functionalities of the network device 100 of this disclosure.

The mirror buffer 4 may be implemented by random access memory (RAM), double data rate synchronous dynamic random access memory (DDR SDRAM), read only memory (ROM), programmable ROM (PROM), flash memory, a hard disk drive (HDD), a solid state disk (SSD), electrically-erasable programmable read-only memory (EEPROM) or any other volatile/non-volatile memory devices, but is not limited thereto.

It is worthy of note that in order to enhance efficiency of data transmission to achieve a throughput speedup, rather than transferring received ones of the NFS request packets to the NFS server 102 to enable the NFS server 102 to send the corresponding ones of the NFS reply packets, the network device 100 may utilize a prefetching technique to prefetch the corresponding ones of the NFS reply packets from the NFS server 102 by generating and sending prefetched packets (which are identical respectively to the aforesaid received ones of the NFS request packets to be received from the at least one client device 101) to the NFS server 102 in advance of receiving the aforesaid received ones of the NFS request packets from the at least one client device 101. For example, prior to receiving the NFS request packet containing the XID of 301 from the at least one client device 101, the network device 100 may generate and send to the NFS server 102 the prefetched packet that is identical to the NFS request packet containing the XID of 301, so as to obtain in advance (i.e., to prefetch) from the NFS server 102 the NFS reply packet containing the XID of 301, which contains a data block that has not yet been requested by the at least one client device 101.

The pre-fetch counter 8 is configured to record a counter value, which is usually implemented to be a non-negative integer, e.g., 0, 1, 2, 3 and so on. In this embodiment, the counter value ranges from zero to a preset pre-fetch number, where the preset pre-fetch number is a positive integer (e.g., three) and represents an upper limit of a number of the prefetched packets to be generated and to be sent by the network device 100 to the NFS server 102. The counter value is zero by default.

The storage-manager register 9 is configured to record the XIDs and a state of each of the XIDs. The state of each XID recorded in the storage-manager register 9 may be one of a “REQUESTED” state and a “PRE-FETCH” state. The “REQUESTED” state indicates that the network device 100 has received from the at least one client device 101 one of the NFS request packets that corresponds to the XID thus recorded but has not yet received from the NFS server 102 a corresponding one of the NFS reply packets. The “PRE-FETCH” state indicates that one of the NFS request packets that corresponds to the XID contained in the reply packet was generated by the network device 100 and sent to the NFS server 102 (i.e., the prefetched packet has been generated and sent by the network device 100 to the NFS server 102) before the network device 100 receives said one of the NFS request packets from the at least one client device 101. The “REQUESTED” state and the “PRE-FETCH” state may be respectively implemented to be two different logical values (e.g., 0 and 1) recorded by the storage-manager register 9, but are not limited thereto.

Each of the pre-fetch counter 8 and the storage-manager register 9 is implemented by a register (which may be realized by static random access memory, SRAM), but is not limited thereto.

Since the P4 hardware switch has been well known to one skilled in the relevant art, detailed explanation of the same is omitted herein for the sake of brevity.

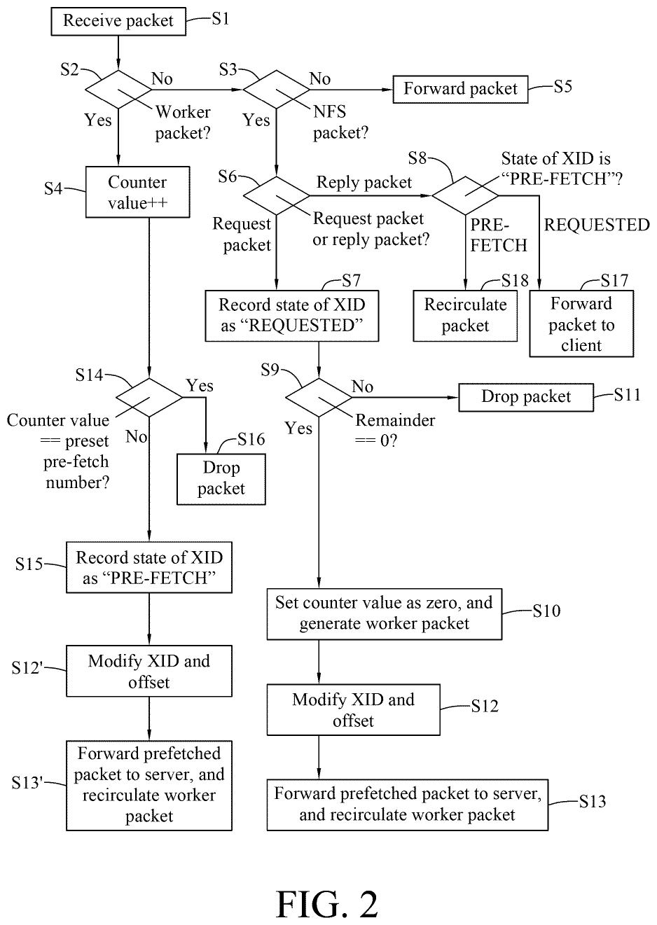

Referring to FIG. 2, a first embodiment of a method for transmitting data using NFS according to the disclosure is illustrated. The method is adapted to be implemented by the network device 100 that was previously described. In this embodiment, the at least one client device 101 includes only one client device 101, which is used to send the NFS request packets to the network device 100 via one of the at least one input port 6 of the network device 100, and used to receive the NFS reply packets from the network device 100 via one of the at least one output port 7 of the network device 100. The method includes steps S1 to S18, S12′ and S13′ delineated below.

In step S1, the IMAP module 1 of the network device 100 receives a to-be-processed packet.

In step S2, the TMPB module 2 of the network device 100 determines, based on a header of the to-be-processed packet thus received, whether the to-be-processed packet is a worker packet. In response to receiving the worker packet, a procedure flow of the method proceeds to step S4. On the other hand, in response to determining that the to-be-processed packet is not the worker packet, the procedure flow proceeds to step S3. It is worthy of note that the worker packet is recirculated from the EMAP module 3 via to the IMAP module 1, and is a transient packet that exists solely within the network device 100 for implementing the method according the disclosure until it is no longer needed. The worker packet may be implemented to be indicated by a specific value stored in a field of a header of the worker packet, and the specific value stored in the field of the header of the worker packet will be modified (e.g., to be removed) when the worker packet leaves the network device 100.

In step S3, the TMPB module 2 determines, based on the header of the to-be-processed packet, whether or not the to-be-processed packet is an NFS packet that supports NFVv3. In response to determining that the to-be-processed packet is not the NFS packet, the procedure flow proceeds to step S5. Contrarily, in response to determining that the to-be-processed packet is the NFS packet, the procedure flow proceeds to step S6.

In step S5, the TMPB module 2 forwards the to-be-processed packet to a destination indicated by the to-be-processed packet through the EMAP module 3 via the at least one output port 7.

In step S6, the TMPB module 2 analyzes the header of the to-be-processed packet to determine whether the network device 100 receives one request packet among the NFS request packets from the IMAP module 1, or receives one reply packet among the NFS reply packets from the IMAP module 1. In response to receiving one request packet among the NFS request packets, the procedure flow proceeds to step S7. In response to receiving one reply packet among the NFS reply packets, the procedure flow proceeds to step S8.

In step S7, the TMPB module 2 records the XID contained in the request packet in the storage-manager register 9, and sets, in the storage-manager register 9, a state of the XID thus recorded as the “REQUESTED” state. It is worthy of note that in a scenario where the XID contained in the request packet is 300, the state of the XID recorded in the storage-manager register 9 can be expressed by a value of an element with an array index equal to the XID (i.e., 300) in a one-dimensional array as “storage_mgr[300]=REQUESTED”, wherein “storage_mgr” stands for the storage-manager register 9 and “storage_mgr[300]” represents the element with the array index of 300 in the one-dimensional array. Then, the procedure flow proceeds to step S9.

In step S9, the TMPB module 2 performs a modulo operation to obtain a remainder of a division of the offset contained in the request packet by a product of the preset block size and the preset pre-fetch number, and determines whether the remainder is equal to zero. In mathematics, the aforesaid operation can be expressed as “offset % (block_size×P)”, where “offset” represents the offset contained in the request packet, “block_size” represents the preset block size, and “P” represents the preset pre-fetch number. In the case that the remainder is not equal to zero, the procedure flow proceeds to step S11. Otherwise, in the case that the remainder is equal to zero, the procedure flow proceeds to step S10.

In step S11, the TMPB module 2 drops the request packet.

In step S10, the TMPB module 2 sets the counter value recorded in pre-fetch counter 8 to zero. At the same time, the TMPB module 2 mirrors the request packet to obtain, in the mirror buffer 4, a mirrored copy of the request packet, forwards the mirrored copy of the request packet to the NFS server 102 through the EMAP module 3, and modifies the packet type indicated by the header of the request packet to obtain the worker packet. After that, the procedure flow proceeds to step S12.

In step S12, the TMPB module 2 modifies the XID contained in the worker packet into one of the XIDs that is immediately subsequent to the XID of the worker packet, and modifies the offset contained in the worker packet by incrementing the offset by the preset block size. Specifically, in this embodiment, the TMPB module 2 modifies the XID contained in the worker packet by incrementing the XID contained in the worker packet by one. For example, the TMPB module 2 increments the XID of 300 by one to the XID of 301, i.e., 300+1=301, and increments an offset of 0 by the preset block size of 8192 as 8192, i.e., 0+8192=8192. After modifying the XID and the offset contained in the worker packet, the procedure flow proceeds to step S13.

In step S13, the TMPB module 2 mirrors the worker packet to obtain, in the mirror buffer 4, a mirrored copy of the worker packet. Subsequently, the TMPB module 2 modifies the packet type of the mirrored copy of the worker packet to obtain the prefetched packet identical to a next one of the NFS request packets that is immediately subsequent to the request packet from which the worker packet is derived and that is to be sent to the NFS server 102, forwards the prefetched packet to the NFS server 102 through the EMAP module 3, and recirculates the worker packet from the EMAP module 3 to the IMAP module 1 via the recirculation port 5 after modifying the XID and the offset contained in the worker packet.

In step S8, the TMPB module 2 determines whether the state of the XID contained in the reply packet that has been recorded in the storage-manager register 9 is the “PRE-FETCH” state. For example, in a scenario where the XID contained in the reply packet is 300, the TMPB module 2 determines whether the value recorded in the element with the array index of 300 in the one-dimensional array, i.e., “storage_mgr[300]”, is the “PRE-FETCH” state. In response to determining that the state of the XID is not the “PRE-FETCH” state (i.e., the state of the XID is the “REQUESTED” state), the procedure flow proceeds to step S17. Oppositely, in response to determining that the state of the XID is the “PRE-FETCH” state, the procedure flow proceeds to step S18.

In step S17, the TMPB module 2 forwards the reply packet to the client device 101 through the EMAP module 3. For example, in a scenario where the state of the XID of 300 is the “REQUESTED” state, i.e., “storage_mgr[300]=REQUESTED”, which means that the client device 101 has sent the NFS request packet containing the XID of 300 to the network device 100, in response to receiving the NFS reply packet containing the XID of 300 from the NFS server 102, the network device 100 would forward the NFS reply packet to the client device 101.

In step S18, the TMPB module 2 recirculates the reply packet from the EMAP module 3 to the IMAP module 1 via the recirculation port 5. For example, in a scenario where the states of the XIDs of 301 and 302 are both the “PRE-FETCH” state, i.e., “storage_mgr[301]=PRE-FETCH” and “storage_mgr[302]=PRE-FETCH”, which means that the client device 101 has not yet sent the NFS request packets containing the XIDs of 301 and 302 to the network device 100, in response to receiving the NFS reply packets containing the XIDs of 301 and 302 from the NFS server 102, the network device 100 would recirculate the NFS reply packets via the recirculation port 5 until receiving the NFS request packets containing the XIDs of 301 and 302 from the client device 101.

In step S4, the TMPB module 2 increments the counter value recorded in the pre-fetch counter 8 by one. After incrementing the counter value, the procedure flow proceeds to step S14.

In step S14, the TMPB module 2 determines whether the counter value is equal to the preset pre-fetch number. In the case that the counter value is equal to the preset pre-fetch number, the procedure flow proceeds to step S16. Oppositely, in the case that that the counter value is not equal to the preset pre-fetch number, the procedure flow proceeds to step S15.

In step S16, the TMPB module 2 drops the worker packet.

In step S15, the TMPB module 2 records the XID contained in the worker packet in the storage-manager register 9, and sets, in the storage-manager register 9, a state of the XID thus recorded as the “PRE-FETCH” state. Then, the procedure flow proceeds to step S12′.

In step S12′, the TMPB module 2 modifies the XID contained in the worker packet into one of the XIDs that is immediately subsequent to the XID contained in the worker packet, and modifies the offset contained in the worker packet by incrementing the offset by the preset block size. Specifically, in this embodiment, the TMPB module 2 modifies the XID contained in the worker packet by incrementing the XID contained in the worker packet by one. After modifying the XID and the offset contained in the worker packet, the procedure flow proceeds to step S13′.

In step S13′, the TMPB module 2 mirrors the worker packet to obtain, in the mirror buffer 4, a mirrored copy of the worker packet, modifies the packet type of the mirrored copy of the worker packet to obtain another prefetched packet identical to one of the NFS request packets that contains the XID identical to the XID of the worker packet which has been modified and that is to be sent to the NFS server 102, and forwards said another prefetched packet to the NFS server 102 through the EMAP module 3 via the at least one output port 7. In addition, the TMPB module 2 recirculates the worker packet from the EMAP module 3 to the IMAP module 1 via the recirculation port 5 after modifying the XID and the offset contained in the worker packet.

For explanation, in a scenario where the preset pre-fetch number is three, the preset block size is 8192, the counter value recorded in the pre-fetch counter 8 is zero, and the worker packet contains the XID of 301 and the offset of 8192, in response to receiving the worker packet recirculated from the EMAP module 3 to the IMAP module 1 via the recirculation port 5, the TMPB module 2 increments the counter value by one so that the counter value is one (step S4), determines that the counter value is not equal to the preset pre-fetch number (no in step S14), sets the state of the XID of 301 as the “PRE-FETCH” state (i.e., “storage_mgr[301]=PRE-FETCH”) in the storage-manager register 9 (step S15), increments the XID contained in the worker packet by one to 302 and increments the offset contained in the worker packet by the preset block size to 16384 (step S12′), recirculates the worker packet containing the XID of 302 and the offset of 16384 via the recirculation port 5, and generates and sends a prefetched packet containing the XID of 302 and the offset of 16384 to the NFS server 102 (step S13′). Similarly, in response to receiving the worker packet (which contains the XID of 302 and the offset of 16384) recirculated from the EMAP module 3 to the IMAP module 1 via the recirculation port 5, the TMPB module 2 increments the counter value by one to be two (step S4), determines that the counter value is not equal to the preset pre-fetch number (no in step S14), sets the state of the XID of 302 as the “PRE-FETCH” state (i.e., “storage_mgr[302]=PRE-FETCH”) in the storage-manager register 9 (step S15), increments the XID contained in the worker packet by one to 303 and increments the offset contained in the worker packet by the preset block size to 24576 (step S12′), recirculates the worker packet containing the XID of 303 and the offset of 24576 via the recirculation port 5, and generates and sends a prefetched packet containing the XID of 303 and the offset of 24576 to the NFS server 102 (step S13′). Again, in response to receiving the worker packet (which contains the XID of 303 and the offset of 24576) recirculated from the EMAP module 3 to the IMAP module 1 via the recirculation port 5, the TMPB module 2 increments the counter value by one to be three (step S4), determines that the counter value is equal to the preset pre-fetch number (yes in step S14), and drops the worker packet (step S16). That is to say, in response to receiving the NFS request packet containing the XID of 300 from the client device 101, besides transferring the NFS request packet containing the XID of 300 to the NFS server 102, the network device 100 would sequentially generate and send three prefetched packets containing the XIDs of 301 to 303 to the NFS server 102 for prefetching the NFS reply packets containing the XIDs of 301 to 303, thereby improving the throughput.

In an experiment where the specific file to be accessed has a file size of 100 MB and a round-trip time (RTT) between the client device 101 and the NFS server 102 is 1.2 millisecond, a throughput of 175 MB/sec was achieved under conventional NFSv3 (which is equivalent to that where the preset pre-fetch number is equal to zero). In comparison, when the first embodiment of the method was used, a throughput of 190 MB/sec was achieved in a condition where the preset pre-fetch number is 32, a throughput of 250 MB/sec was achieved in a condition where the preset pre-fetch number is 64, and a throughput of 345 MB/sec was achieved in a condition where the preset pre-fetch number is 128. It is apparent that throughput is effectively improved when the method according to the disclosure is used.

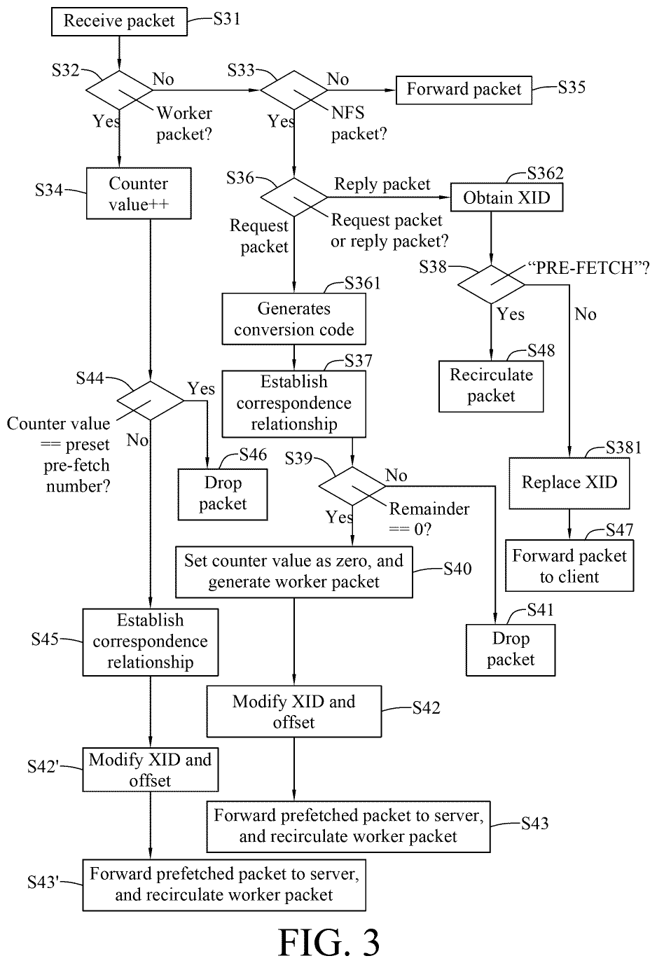

Referring to FIG. 3, a second embodiment of the method for transmitting data using NFS according to the disclosure is illustrated. The method is adapted to be implemented by the TMPB module 2 of the network device 100 that was previously described. In this embodiment, the at least one client device 101 includes a plurality of client devices 101. Each of the client devices 101 corresponds to a respective one of the at least one input port 6, and a respective one of the at least one output port 7. Said each of the client devices 101 is used to send the NFS request packets to the network device 100 via the respective one of the at least one input port 6 of the network device 100, and to receive the NFS reply packets from the network device 100 via the respective one of the at least one output port 7 of the network device 100. However, it should be noted that the second embodiment of the method is also applicable to a situation where there is only a single client device 101. Moreover, each of the NFS request packets further contains a file handler that is an integer and that is uniquely related to the specific file in NFS. The method includes steps S31 to S48, S42′, S43′, S361, S362 and S381 delineated below.

In step S31, the IMAP module 1 of the network device 100 receives a to-be-processed packet.

In step S32, the TMPB module 2 determines, based on a header of the to-be-processed packet thus received, whether the to-be-processed packet is the worker packet. In response to receiving the worker packet, the procedure flow of the method proceeds to step S34. On the other hand, in response to determining that the to-be-processed packet is not the worker packet, the procedure flow proceeds to step S33.

In step S33, the TMPB module 2 determines, based on the header of the to-be-processed packet, whether or not the to-be-processed packet is the NFS packet. In response to determining that the to-be-processed packet is not the NFS packet, the procedure flow proceeds to step S35. Contrarily, in response to determining that the to-be-processed packet is the NFS packet, the procedure flow proceeds to step S36.

In step S35, the TMPB module 2 forwards the to-be-processed packet to a destination indicated by the to-be-processed packet through the EMAP module 3 via one of the at least one output port 7.

In step S36, the TMPB module 2 analyzes the header of the to-be-processed packet to determine whether the network device 100 receives, from the IMAP module 1, one request packet among the NFS request packets sent by one of the client devices 101, or receives, from the IMAP module 1, one reply packet among the NFS reply packets to be sent to one of the client devices 101. In response to receiving one request packet among the NFS request packets, the procedure flow proceeds to step S361. In response to receiving one reply packet among the NFS reply packets, the procedure flow proceeds to step S362.

In step S361, the TMPB module 2 generates a conversion code based on the file handler and the offset that are contained in the request packet, the preset block size and the preset pre-fetch number. Specifically, the TMPB module 2 calculates a quotient of the offset and the preset block size, calculates a remainder of a division of the quotient by the preset pre-fetch number, and performs bitwise concatenation on the file handler and the remainder. In mathematics, the above-mentioned calculation can be expressed as “file_handle++(offset/block_size) % P”, where “++” is bitwise concatenation (e.g., 0x1++0x1=0x11), “file_handle” represents the file handler contained in the request packet, “offset” represents the offset contained in the request packet, “block_size” represents the preset block size, and “P” represents the preset pre-fetch number. Subsequently, the TMPB module 2 uses a result of the bitwise concatenation to obtain the conversion code. For example, in a scenario where the preset pre-fetch number is three, the preset block size is 8192, and the network device 100 receives a first request packet (which contains a file handler of one, an offset of zero, and an XID of 300) from a first client device and receives a second request packet (which contains a file handler of two, an offset of zero, and an XID of 301) from a second client device, the TMPB module 2 would obtain a first conversion code of 0x100 for the first request packet and a second conversion code of 0x200 for the second request packet. Then, the procedure flow proceeds to step S37.

In step S37, the TMPB module 2 establishes, in the storage-manager register 9, a correspondence relationship at least between the conversion code and the XID contained in the request packet, wherein the XID contained in the request packet serves as a notation representing the “REQUESTED” state. At the same time, the TMPB module 2 replaces the XID contained in the request packet with the conversion code. Then, the procedure flow proceeds to step S39. Specifically, the correspondence relationship thus established is between the XID contained in the request packet and a pair of the conversion code and a port number of one of the at least one input port 6 from which the request packet was received (i.e., the respective one of the at least one input port 6 to which one of the client devices 101 sending the request packet corresponds). It is worthy of note that the aforesaid correspondence relationship can be recorded in an element of a two-dimensional array as “storage_mgr[port][conversion_code]=XID”, wherein a first array index “[port]” of the element is related to the port number of the one of the at least one input port 6 from which the request packet was received, a second array index “[conversion_code]” of the element is related to the conversion code, and a value “XID” recorded in the element is the XID contained in the request packet. Continuing with the previous example, in a scenario where the first request packet was received via one of the at least one input port 6 having a port number of zero and the second request packet was received via one of the at least one input port 6 having a port number of one, the TMPB module 2 would establish, in the storage-manager register 9, a first correspondence relationship for the first request packet as “storage_mgr[0][0x100]=300”, and a second correspondence relationship for the second request packet as “storage_mgr[1][0x200]=301”. It should be noted that in this embodiment, the “PRE-FETCH” state is implemented to be a special notation that is different from all of the XIDs contained in the NFS request packets and that will never be used as an XID for file exchange.

In step S39, the TMPB module 2 performs a modulo operation to obtain a remainder of a division of the offset contained in the request packet by a product of the preset block size and the preset pre-fetch number, and determines whether the remainder is equal to zero. In the case that the remainder is not equal to zero, the procedure flow proceeds to step S41. Otherwise, in the case that the remainder is equal to zero, the procedure flow proceeds to step S40. Since this step is similar to step S9 in the first embodiment of the method, detailed explanation of the same is omitted herein for the sake of brevity.

In step S41, similar to step S11 in the first embodiment of the method, the TMPB module 2 drops the request packet.

In step S40, similar to step S10 in the first embodiment of the method, the TMPB module 2 sets the counter value recorded in the pre-fetch counter 8 to zero. At the same time, the TMPB module 2 mirrors the request packet to obtain, in the mirror buffer 4, a mirrored copy of the request packet, forwards the mirrored copy of the request packet to the NFS server 102 through the EMAP module 3, and modifies the packet type indicated by the header of the request packet to obtain the worker packet. After that, the procedure flow proceeds to step S42. Continuing with the previous example, after replacing the XID contained in the first request packet (which currently contains the file handler of one, the offset of zero, and the conversion code 0x100 serving as the XID) and determining that the remainder is equal to zero, the TMPB module 2 mirrors the first request packet to obtain a mirrored copy of the first request packet, forwards the mirrored copy of the first request packet to the NFS server 102, and modifies the packet type indicated by the header of the first request packet to obtain the worker packet.

In step S42, the TMPB module 2 modifies the XID contained in the worker packet into one of the XIDs that is immediately subsequent to the XID of the worker packet, and modifies the offset contained in the worker packet by incrementing the offset by the preset block size. Specifically, in this embodiment, the TMPB module 2 modifies the XID contained in the worker packet by incrementing the XID contained in the worker packet by one. However, it should be noted that the way of modifying the XID contained in the worker packet depends on a predefined pattern of the XIDs, and is not limited to the disclosure herein and may vary in other embodiments. For example, in a scenario where XIDs are an arithmetic sequence with a common difference of two, the TMPB module 2 would modify the XID by incrementing the XID by two. After modifying the XID and the offset contained in the worker packet, the procedure flow proceeds to step S43. Continuing with the previous example, the TMPB module 2 increments the XID (i.e., 0x100) contained in the worker packet derived from the first request packet by one as 0x101, and increments the offset (i.e., 0) contained in the worker packet by the preset block size (i.e., 8192) as 8192. Currently, the worker packet contains the XID of 0x101, the file handler of one, and the offset of 8192.

In step S43, the TMPB module 2 mirrors the worker packet to obtain, in the mirror buffer 4, a mirrored copy of the worker packet. Subsequently, the TMPB module 2 modifies the packet type of the mirrored copy of the worker packet to obtain the prefetched packet identical to a next one of the NFS request packets that is immediately subsequent to the request packet from which the worker packet is derived and that is to be sent to the NFS server 102, forwards the prefetched packet to the NFS server 102 through the EMAP module 3, and recirculates the worker packet from the EMAP module 3 to the IMAP module 1 via the recirculation port 5 after modifying the XID and the offset contained in the worker packet. It is worthy of note that besides transferring the NFS request packet containing the XID of 300 to the NFS server 102, the network device 100 further send a prefetched packets containing the XID of 0x101 to the NFS server 102 for prefetching an additional NFS reply packet, thereby improving the throughput.

In step S362, the TMPB module 2 obtains the XID contained in the reply packet. Then, the procedure flow proceeds to step S38.

In step S38, the TMPB module 2 determines, based on the storage-manager register 9, whether the conversion code conforming with the XID contained in the reply packet corresponds to the “PRE-FETCH” state. Specifically, the TMPB module 2 finds an element of the two-dimensional array that has the second array index conforming with the XID contained in the reply packet, and then determines whether a value recorded in the element thus found is the special notation representing the “PRE-FETCH” state. In response to determining that the conversion code does not correspond to the “PRE-FETCH” state (i.e., the value recorded in the element thus found is one of the XIDs), the procedure flow proceeds to step S381. Alternatively, in response to determining that the conversion code corresponds to the “PRE-FETCH” state (i.e., the value recorded in the element thus found is the special notation representing the “PRE-FETCH” state), the procedure flow proceeds to step S48. For example, in a scenario where the XID contained in the reply packet is 0x100, at first, the TMPB module 2 would find an element of the two-dimensional array that has the second array index conforming with the XID contained in the reply packet, i.e., “storage_mgr[0][0x100]”. Then, the TMPB module 2 would determine whether a value recorded in the element thus found is the special notation representing the “PRE-FETCH” state. Since the correspondence relationship established in the two-dimensional array is “storage_mgr[0][0x100]=300”, i.e., the value recorded in the element “storage_mgr[0][0x100]” is “300”, which is one of the XIDs rather than the special notation representing the “PRE-FETCH” state, the TMPB module 2 would determine that the conversion code does not correspond to the “PRE-FETCH” state.

In step S381, the TMPB module 2 replaces the XID contained in the reply packet with the XID corresponding to the conversion code in the storage-manager register 9 (i.e., the XID with which the conversion code cooperatively have a correspondence relationship established in the storage-manager register 9 in step S37). Continuing with the previous example, the TMPB module 2 would replace the XID contained in the reply packet (i.e., 0x100) with the XID corresponding to the conversion code in the storage-manager register 9 (i.e., 300). Thereafter, the procedure flow proceeds to step S47.

In step S47, the TMPB module 2 forwards the reply packet, the XID of which has been replaced, to the one of the client devices 101. Continuing with the previous example, the TMPB module 2 forwards the replay packet containing the XID of 300 to the one of the client devices 101.

In step S48, the TMPB module 2 recirculates the reply packet from the EMAP module 3 to the IMAP module 1 via the recirculation port 5.

In step S34, the TMPB module 2 increments the counter value recorded in the pre-fetch counter 8 by one. After incrementing the counter value, the procedure flow proceeds to step S44.

In step S44, similar to step S14 in the first embodiment of the method, the TMPB module 2 determines whether the counter value thus incremented is equal to the preset pre-fetch number. In the case that the counter value is equal to the preset pre-fetch number, the procedure flow proceeds to step S46. Conversely, in the case that that the counter value is not equal to the preset pre-fetch number, the procedure flow proceeds to step S45.

In step S46, similar to step S16 in the first embodiment of the method, the TMPB module 2 drops the worker packet.

In step S45, the TMPB module 2 establishes, in the storage-manager register 9, a correspondence relationship at least between the XID contained in the worker packet and the “PRE-FETCH” state. Then, the procedure flow proceeds to step S42′. Specifically, the correspondence relationship thus established is between the “PRE-FETCH” state and a pair of the XID contained in the worker packet and a port number of one of the at least one input port 6 that corresponds to the request packet via which the worker packet is directly or indirectly derived. It is worthy of note that the aforesaid correspondence relationship can be recorded in an element of the two-dimensional array as “storage_mgr[port][XID]=PRE-FETCH”, wherein a first array index “[port]” of the element is related to the port number of the one of the at least one input port 6 that corresponds to the request packet via which the worker packet is directly or indirectly derived, a second array index “[XID]” of the element is related to the XID contained in the worker packet, and a value “RE-FETCH” recorded in the element is the special notation representing the “PRE-FETCH” state.

In step S42′, the TMPB module 2 modifies the XID contained in the worker packet into one of the XIDs that is immediately subsequent to the XID contained in the worker packet, and modifies the offset contained in the worker packet by incrementing the offset by the preset block size. Specifically, in this embodiment, the TMPB module 2 modifies the XID contained in the worker packet by incrementing the XID contained in the worker packet by one. After modifying the XID and the offset contained in the worker packet, the procedure flow proceeds to step S43′.

In step S43′, the TMPB module 2 mirrors the worker packet to obtain, in the mirror buffer 4, a mirrored copy of the worker packet, modifies the packet type of the mirrored copy of the worker packet to obtain another prefetched packet identical to one of the NFS request packets that contains the XID identical to the XID of the worker packet which has been modified and that is to be sent to the NFS server 102, and forwards said another prefetched packet to the NFS server 102 through the EMAP module 3. In addition, the TMPB module 2 recirculates the worker packet from the EMAP module 3 to the IMAP module 1 via the recirculation port 5 after modifying the XID and the offset contained in the worker packet.

For explanation, in a scenario where the preset pre-fetch number is three, the preset block size is 8192, the counter value recorded in the pre-fetch counter 8 is zero, and the worker packet contains the XID of 0x101 and the offset of 8192, in response to receiving the worker packet recirculated from the EMAP module 3 to the IMAP module 1 via the recirculation port 5, the TMPB module 2 increments the counter value by one so that the counter value is one (step S34), determines that the counter value is not equal to the preset pre-fetch number (no in step S44), establishes a correspondence relationship at least between the XID contained in the worker packet and the “PRE-FETCH” state (i.e., “storage_mgr[0][0x101]=PRE-FETCH”) in the storage-manager register 9 (step S45), increments the XID contained in the worker packet by one to 0x102 and increments the offset contained in the worker packet by the preset block size to 16384 (step S42′), recirculates the worker packet containing the XID of 0x102 and the offset of 16384 via the recirculation port 5, and generates and sends a prefetched packet containing the XID of 0x102 and the offset of 16384 to the NFS server 102 (step S43′).

To sum up, in the method for transmitting data using NFS according to the disclosure, the network device 100 uses the prefetching technique to prefetch some of the NFS reply packets from the NFS server 102 before receiving the corresponding ones of the NFS request packets from the at least one client device 101. Such approach is like using the Go-Back-N protocol to transfer a file. In this way, throughput degradation in NFS caused by an increased RTT between the at least one client device 101 and the NFS server 102 may be mitigated.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for transmitting data using Network File System (NFS), adapted to be implemented by a network device that communicates with at least one client device and an NFS server, the at least one client device sequentially sending multiple NFS request packets via the network device to the NFS server for accessing a specific file stored in the NFS server, the NFS server sequentially sending multiple NFS reply packets that respectively correspond to the NFS request packets via the network device to the at least one client device for providing the specific file to the at least one client device, each of the NFS request packets and the NFS reply packets including a header that contains a transaction identifier (XID), the XID of one of the NFS request packets and the XID of a corresponding one of the NFS reply packets being identical, the XIDs respectively of the NFS request packets sequentially sent to the NFS server being sequential, each of the NFS request packets at least containing an offset that is defined by NFS and that is an integer, each of the headers of the NFS request packets and the NFS reply packets indicating a packet type, the network device including a pre-fetch counter and a storage-manager register, the method comprising:
in response to receiving one request packet among the NFS request packets,
recording the XID contained in the request packet in the storage-manager register,
setting, in the storage-manager register, a state of the XID thus recorded as a “REQUESTED” state, which indicates that the network device has received one of the NFS request packets that corresponds to the XID thus recorded from the at least one client device but has not yet received a corresponding one of the NFS reply packets from the NFS server,
performing a modulo operation to obtain a remainder of a division of the offset contained in the request packet by a product of a preset block size and a preset pre-fetch number, where the preset block size is defined by NFS and each of the preset block size and the preset pre-fetch number is a positive integer,
in the case that the remainder is not equal to zero, dropping the request packet,
in the case that the remainder is equal to zero,
setting a counter value recorded in the pre-fetch counter to zero,
mirroring the request packet to obtain a mirrored copy of the request packet,
forwarding the mirrored copy of the request packet to the NFS server,
modifying the packet type indicated by the header of the request packet to obtain a worker packet,
modifying the XID contained in the worker packet into one of the XIDs that is immediately subsequent to the XID of the worker packet,
modifying the offset contained in the worker packet by incrementing the offset by the preset block size,
after modifying the XID and the offset contained in the worker packet, mirroring the worker packet to obtain a mirrored copy of the worker packet,
modifying the packet type of the mirrored copy of the worker packet to obtain a prefetched packet identical to a next one of the NFS request packets that is immediately subsequent to the request packet from which the worker packet is derived and that is to be sent to the NFS server,
forwarding the prefetched packet to the NFS server, and
after modifying the XID and the offset contained in the worker packet, recirculating the worker packet; and
in response to receiving one reply packet among the NFS reply packets,
determining whether the state of the XID contained in the reply packet that has been recorded in the storage-manager register is a “PRE-FETCH” state, which indicates that one of the NFS request packets that corresponds to the XID contained in the reply packet was generated by the network device and sent to the NFS server before the network device receives said one of the NFS request packets from the at least one client device, and
in response to determining that the state of the XID is not the “PRE-FETCH” state, forwarding the reply packet to the at least one client device.

2. The method as claimed in claim 1, the XIDs contained in the NFS request packets sequentially sent to the NFS server being consecutive positive integers,
wherein modifying the XID contained in the worker packet is to increment the XID contained in the worker packet by one.

3. The method as claimed in claim 1, further comprising, in response to receiving the worker packet:
incrementing the counter value recorded in the pre-fetch counter by one;
after incrementing the counter value, determining whether the counter value is equal to the preset pre-fetch number;
dropping the worker packet in the case that the counter value is equal to the preset pre-fetch number; and
in the case that that the counter value is not equal to the preset pre-fetch number,
recording the XID contained in the worker packet in the storage-manager register,
setting, in the storage-manager register, a state of the XID thus recorded as the “PRE-FETCH” state,
modifying the XID contained in the worker packet into one of the XIDs that is immediately subsequent to the XID contained in the worker packet,
modifying the offset contained in the worker packet by incrementing the offset by the preset block size,
after modifying the XID and the offset contained in the worker packet, mirroring the worker packet to obtain a mirrored copy of the worker packet,
modifying the packet type of the mirrored copy of the worker packet to obtain another prefetched packet identical to one of the NFS request packets that contains the XID identical to the XID of the worker packet which has been modified and that is to be sent to the NFS server,
forwarding said another prefetched packet to the NFS server, and
after modifying the XID and the offset contained in the worker packet, recirculating the worker packet.

4. The method as claimed in claim 1, further comprising:
in response to determining that the state of the XID contained in the reply packet is the “PRE-FETCH” state, recirculating the reply packet.

5. The method as claimed in claim 1, the network device communicating with multiple client devices, each of the NFS request packets further containing a file handler that is an integer and that is uniquely related to the specific file in NFS, wherein:
in response to receiving one request packet among the NFS request packets sent by one of the client devices, recording the XID in the storage-manager register and setting the state of the XID as a “REQUESTED” state are cooperatively implemented by
generating a conversion code based on the file handler and the offset that are contained in the request packet, the preset block size and the preset pre-fetch number,
establishing, in the storage-manager register, a correspondence relationship at least between the conversion code and the XID contained in the request packet, the XID contained in the request packet serving as a notation representing the “REQUESTED” state, and
replacing the XID contained in the request packet with the conversion code; and
in response to receiving one reply packet among the NFS reply packets to be sent to one of the client devices,
the determining of whether the state of the XID is a “PRE-FETCH” state includes determining, based on the storage-manager register, whether the conversion code conforming with the XID contained in the reply packet corresponds to the “PRE-FETCH” state, and
in response to determining that the conversion code does not correspond to the “PRE-FETCH” state, the method further comprising, prior to forwarding the reply packet to the one of the client devices, replacing the XID contained in the reply packet with the XID corresponding to the conversion code in the storage-manager register.

6. The method as claimed in claim 5, wherein, in response to receiving one request packet among the NFS request packets sent by one of the client devices, the generating of the conversion code includes:
calculating a quotient of the offset and the preset block size;
calculating a remainder of a division of the quotient by the preset pre-fetch number;
performing bitwise concatenation on the file handler and the remainder; and
using a result of the bitwise concatenation to obtain the conversion code.

7. The method as claimed in claim 5, further comprising, in response to receiving the worker packet:
incrementing the counter value recorded in the pre-fetch counter by one;
determining whether the counter value thus incremented is equal to the preset pre-fetch number;
dropping the worker packet in the case that the counter value is equal to the preset pre-fetch number; and
in the case that the counter value is not equal to the preset pre-fetch number,
establishing, in the storage-manager register, a correspondence relationship at least between the XID contained in the worker packet and the “PRE-FETCH” state,
modifying the XID contained in the worker packet into one of the XIDs that is immediately subsequent to the XID contained in the worker packet,
modifying the offset contained in the worker packet by incrementing the offset by the preset block size,
after modifying the XID and the offset contained in the worker packet, mirroring the worker packet to obtain a mirrored copy of the worker packet,
modifying the packet type of the mirrored copy of the worker packet to obtain another prefetched packet identical to one of the NFS request packets that contains the XID identical to the XID of the worker packet which has been modified and that is to be sent to the NFS server,
forwarding said another prefetched packet to the NFS server, and
after modifying the XID and the offset contained in the worker packet, recirculating the worker packet.

8. The method as claimed in claim 5, further comprising, in response to receiving one reply packet among the NFS reply packets to be sent to one of the client devices:
recirculating the reply packet in response to determining, based on the storage-manager register, that the conversion code corresponds to the “PRE-FETCH” state.

9. A network device for transmitting data using Network File System (NFS), adapted to communicate with at least one client device and an NFS server, the at least one client device sequentially sending multiple NFS request packets via said network device to the NFS server for accessing a specific file stored in the NFS server, the NFS server sequentially sending multiple NFS reply packets that respectively correspond to the NFS request packets via said network device to the at least one client device for providing the specific file to the at least one client device, each of the NFS request packets and the NFS reply packets including a header that contains a transaction identifier (XID), the XID of one of the NFS request packets and the XID of a corresponding one of the NFS reply packets being identical, the XIDs respectively of the NFS request packets sequentially sent to the NFS server being sequential, each of the NFS request packets at least containing an offset that is defined by NFS and that is an integer, each of the headers of the NFS request packets and the NFS reply packets indicating a packet type, said network device comprising:
an ingress match-action pipeline (IMAP) module;
a traffic manager and packet buffer (TMPB) module electrically connected to said IMAP module;
an egress match-action pipeline (EMAP) module electrically connected to said TMPB module;
a mirror buffer electrically connected to said IMAP module, said TMPB module and said EMAP module;
a recirculation port electrically connected to said IMAP module and said EMAP module;
a pre-fetch counter; and
a storage-manager register,
wherein said IMAP module is configured to receive the NFS request packets from the at least one client device, to send the NFS request packets thus received to said TMPB module, to receive the NFS reply packets from the NFS server, and to send the NFS reply packets thus received to said TMPB module;
wherein said TMPB module is configured to, in response to receiving one request packet among the NFS request packets from said IMAP module,
record the XID contained in the request packet in said storage-manager register,
set, in said storage-manager register, a state of the XID thus recorded as a “REQUESTED” state, which indicates that said network device has received one of the NFS request packets that corresponds to the XID thus recorded from the at least one client device but has not yet received a corresponding one of the NFS reply packets from the NFS server,
perform a modulo operation to obtain a remainder of a division of the offset contained in the request packet by a product of a preset block size and a preset pre-fetch number, where the preset block size is defined by NFS and each of the preset block size and the preset pre-fetch number is a positive integer,
in the case that the remainder is not equal to zero, drop the request packet,
in the case that the remainder is equal to zero,
set a counter value recorded in said pre-fetch counter to zero,
mirror the request packet to obtain, in said mirror buffer, a mirrored copy of the request packet,
forward the mirrored copy of the request packet to the NFS server through said EMAP module,
modify the packet type indicated by the header of the request packet to obtain a worker packet,
modify the XID contained in the worker packet into one of the XIDs that is immediately subsequent to the XID of the worker packet,
modify the offset contained in the worker packet by incrementing the offset by the preset block size,
after modifying the XID and the offset contained in the worker packet, mirror the worker packet to obtain, in said mirror buffer, a mirrored copy of the worker packet,
modify the packet type of the mirrored copy of the worker packet to obtain a prefetched packet identical to a next one of the NFS request packets that is immediately subsequent to the request packet from which the worker packet is derived and that is to be sent to the NFS server,
forward the prefetched packet to the NFS server through said EMAP module, and
after modifying the XID and the offset contained in the worker packet, recirculate the worker packet from said EMAP module to said IMAP module via said recirculation port,
wherein said TMPB module is further configured to, in response to receiving one reply packet among the NFS reply packets from said IMAP module,
determine whether the state of the XID contained in the reply packet that has been recorded in said storage-manager register is a “PRE-FETCH” state, which indicates that one of the NFS request packets that corresponds to the XID contained in the reply packet was generated by said network device and sent to the NFS server before said network device receives said one of the NFS request packets from the at least one client device, and
in response to determining that the state of the XID is not the “PRE-FETCH” state, forward the reply packet to the at least one client device through said EMAP module.

10. The network device as claimed in claim 9, the XIDs contained in the NFS request packets sequentially sent to the NFS server being consecutive positive integers,
wherein said TMPB module is configured to modify the XID contained in the worker packet by incrementing the XID contained in the worker packet by one.

11. The network device as claimed in claim 9, wherein said TMPB module is further configured to, in response to receiving the worker packet from said IMAP module:
increment the counter value recorded in said pre-fetch counter by one;
after incrementing the counter value, determine whether the counter value is equal to the preset pre-fetch number;
drop the worker packet in the case that the counter value is equal to the preset pre-fetch number; and
in the case that the counter value is not equal to the preset pre-fetch number,
record the XID contained in the worker packet in said storage-manager register,
set, in said storage-manager register, a state of the XID thus recorded as the “PRE-FETCH” state,
modify the XID contained in the worker packet into one of the XIDs that is immediately subsequent to the XID contained in the worker packet,
modify the offset contained in the worker packet by incrementing the offset by the preset block size,
after modifying the XID and the offset contained in the worker packet, mirror the worker packet to obtain, in said mirror buffer, a mirrored copy of the worker packet,
modify the packet type of the mirrored copy of the worker packet to obtain another prefetched packet identical to one of the NFS request packets that contains the XID identical to the XID of the worker packet which has been modified and that is to be sent to the NFS server,
forward said another prefetched packet to the NFS server through said EMAP module, and
after modifying the XID and the offset contained in the worker packet, recirculate the worker packet from said EMAP module to said IMAP module via said recirculation port.

12. The network device as claimed in claim 9, wherein said TMPB module is further configured to, in response to determining that the state of the XID contained in the reply packet is the “PRE-FETCH” state, recirculate the reply packet from said EMAP module to said IMAP module via said recirculation port.

13. The network device as claimed in claim 9, adapted to communicate with multiple client devices, each of the NFS request packets further containing a file handler that is an integer and that is uniquely related to the specific file in NFS,
wherein, in response to receiving, from said IMAP module, one request packet among the NFS request packets sent by one of the client devices, said TMPB module is configured to implement recording the XID in the storage-manager register and setting the state of the XID as a “REQUESTED” state cooperatively by
generating a conversion code based on the file handler and the offset that are contained in the request packet, the preset block size and the preset pre-fetch number,
establishing, in said storage-manager register, a correspondence relationship at least between the conversion code and the XID contained in the request packet, the XID contained in the request packet serving as a notation representing the “REQUESTED” state, and
replacing the XID contained in the request packet with the conversion code;
wherein, in response to receiving, from said IMAP module, one reply packet among the NFS reply packets to be sent to one of the client devices,
said TMPB module is configured to determine, based on said storage-manager register, whether the conversion code conforming with the XID contained in the reply packet corresponds to the “PRE-FETCH” state, and
in response to determining that the conversion code does not correspond to the “PRE-FETCH” state, said TMPB module is further configured to, prior to forwarding the reply packet to the one of the client devices, replace the XID contained in the reply packet with the XID corresponding to the conversion code in said storage-manager register.

14. The network device as claimed in claim 13, wherein, in response to receiving, from said IMAP module, one request packet among the NFS request packets sent by one of the client devices, said TMPB module is configured to generate the conversion code by:
calculating a quotient of the offset and the preset block size;
calculating a remainder of a division of the quotient by the preset pre-fetch number;
performing bitwise concatenation on the file handler and the remainder; and
using a result of the bitwise concatenation to obtain the conversion code.

15. The network device as claimed in claim 13, wherein said TMPB module is further configured to, in response to receiving the worker packet:
increment the counter value recorded in said pre-fetch counter by one;
determine whether the counter value thus incremented is equal to the preset pre-fetch number;
drop the worker packet in the case that the counter value is equal to the preset pre-fetch number; and
in the case that the counter value is not equal to the preset pre-fetch number,
establish, in said storage-manager register, a correspondence relationship at least between the XID contained in the worker packet and the “PRE-FETCH” state,
modify the XID contained in the worker packet into one of the XIDs that is immediately subsequent to the XID contained in the worker packet,
modify the offset contained in the worker packet by incrementing the offset by the preset block size,
after modifying the XID and the offset contained in the worker packet, mirror the worker packet to obtain, in said mirror buffer, a mirrored copy of the worker packet,
modify the packet type of the mirrored copy of the worker packet to obtain another prefetched packet identical to one of the NFS request packets that contains the XID identical to the XID of the worker packet which has been modified and that is to be sent to the NFS server,
forward said another prefetched packet to the NFS server through said EMAP module, and
after modifying the XID and the offset contained in the worker packet, recirculate the worker packet from said EMAP module to said IMAP module via said recirculation port.

16. The network device as claimed in claim 13, wherein said TMPB module is further configured to, in response to receiving, from said IMAP module, one reply packet among the NFS reply packets to be sent to one of the client devices:
recirculate the reply packet from said EMAP module to said IMAP module via said recirculation port in response to determining, based on said storage-manager register, that the conversion code corresponds to the “PRE-FETCH” state.
